(19) United States
(12) Patent Application Publication
(10) Pub. No.: US 2025/0167480 A1
(43) Pub. Date: May 22, 2025

(54) CONNECTOR

(71) Applicant: SUMITOMO WIRING SYSTEMS, LTD., Mie (JP)

(72) Inventor: Kazumi OKA, Mie (JP)

(21) Appl. No.: 18/944,568

(22) Filed: Nov. 12, 2024

(30) Foreign Application Priority Data
Nov. 21, 2023 (JP) 2023-197303

(51) Int. Cl. H01R 13/436; H01R 13/50

(52) U.S. Cl. CPC H01R 13/4368; H01R 13/50

(57) ABSTRACT

A housing 20 is formed with a cavity 25 extending in a front-rear direction. A retainer 60 includes a terminal locking portion 63 projecting forward from a retainer body 62. The retainer 60 moves obliquely forward from a temporary locking position to a complete locking position with respect to the housing 20 and causes a tip part of the terminal locking portion 63 to face a terminal fitting 50 from behind at the complete locking position. Further, the retainer 60 includes protection walls 64 covering the terminal locking portion 63 from both left and right sides on the both left and right sides across the terminal locking portion 63. The protection wall 64 includes a protrusion 69 projecting obliquely forward. The housing 20 includes recesses 36 extending obliquely forward for receiving the protrusions 69 restricted in position in a vertical direction at the complete locking position.

### CROSS-REFERENCE TO RELATED APPLICATIONS

This application is based on and claims priority from Japanese Patent Application No. 2023-197303, filed on Nov. 21, 2023, with the Japan Patent Office, the disclosure of which is incorporated herein in its entirety by reference.

### TECHNICAL FIELD

The present disclosure relates to a connector.

### BACKGROUND

A connector disclosed in Japanese Patent Laid-open Publication No. 2006-120417 is provided with a connector housing and a retainer to be mounted into the connector housing movably between a temporary locking position and a complete locking position. The connector housing is formed with a plurality of cavities extending in a front-rear direction. A terminal fitting is inserted and accommodated into each cavity from behind. The retainer includes a housing locking portion lockable to the connector housing and terminal locking portions projecting forward from the housing locking portion. The retainer moves obliquely forward from the temporary locking position to the complete locking position with respect to the connector housing, and tip parts of the terminal locking portions are caused to face the terminal fittings from behind at the complete locking position. The terminal fitting is locked by the terminal locking portion and restricted from coming out rearward from the cavity. A connector provided with a retainer configured to move obliquely forward is also disclosed in Japanese Patent Laid-open Publication Nos. 2012-022926 and H10-189114.

### SUMMARY

In the case of Japanese Patent Laid-open Publication No. 2006-120417, the tip parts of the terminal locking portions are exposed in a side view and it has been difficult to effectively protect the terminal locking portions from an external matter contacting from a lateral side. Further, when an external force for rotating the retainer about a locked part of the retainer to the housing as a fulcrum acts on the retainer at the time of complete locking and temporary locking, it has been difficult to sufficiently suppress the rotation of the retainer. Thus, the terminal locking portions are displaced downward and locking margins of the terminal locking portions with the terminal fittings may be reduced.

Accordingly, the present disclosure aims to provide a connector capable of ensuring the locking stability (terminal fitting locking) of a terminal locking portion of a retainer for a terminal fitting.

The present disclosure is directed to a connector with a housing formed with a cavity extending in a front-rear direction, a terminal fitting to be accommodated into the cavity with a tip part facing forward, and a retainer to be arranged movably between a temporary locking position and a complete locking position with respect to the housing, the retainer including a retainer body and a terminal locking portion projecting forward from the retainer body, the retainer being configured to move in an oblique forward direction intersecting the front-rear direction from the temporary locking position to the complete locking position with respect to the housing and cause a tip part of the terminal locking portion to face the terminal fitting from behind at the complete locking position, the retainer including protection walls covering the tip part of the terminal locking portion from both left and right sides on the both left and right sides across the terminal locking portion, the protection wall including a protrusion projecting in the oblique forward direction, and the housing including recesses extending in the oblique forward direction for receiving the protrusions restricted in position in a vertical direction at least at the complete locking position.

According to the present disclosure, it is possible to provide a connector capable of ensuring the locking stability (terminal fitting locking) of a terminal locking portion of a retainer for a terminal fitting.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view in section showing a state where a retainer is arranged at a temporary locking position with respect to a housing in a connector of one embodiment.

FIG. 2 is a side view enlargedly showing the state where the retainer is arranged at the temporary locking position with respect to the housing in the connector of the embodiment.

FIG. 3 is a bottom view enlargedly showing the state where the retainer is arranged at the temporary locking position with respect to the housing in the connector of the embodiment.

FIG. 4 is a side view in section showing a state where the retainer is arranged at a complete locking position with respect to the housing in the connector of the embodiment.

FIG. 5 a side view enlargedly showing the state where the retainer is arranged at the complete locking position with respect to the housing in the connector of the embodiment.

FIG. 6 is a bottom view enlargedly showing the state where the retainer is arranged at the complete locking position with respect to the housing in the connector of the embodiment.

FIG. 7 is a back view of the retainer in the connector of the embodiment.

FIG. 8 is a plan view of the retainer in the connector of the embodiment.

FIG. 9 is a side view of the retainer in the connector of the embodiment.

FIG. 10 is a plan view in section enlargedly showing a state where a retainer is arranged at a complete locking position with respect to a housing and a stopped portion is fit and locked to a stopping portion in a connector of another embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

Embodiments of the present disclosure are first listed and described.
(1) The connector of the present disclosure is provided with a housing formed with a cavity extending in a front-rear direction, a terminal fitting to be accommodated into the cavity with a tip part facing forward, and a retainer to be arranged movably between a temporary locking position and a complete locking position with respect to the housing, the retainer including a retainer body and a terminal locking portion projecting forward from the retainer body, the retainer being configured to move in an oblique forward direction intersecting the front-rear direction from the temporary locking position to the complete locking position with respect to the housing and cause a tip part of the terminal locking portion to face the terminal fitting from behind at the complete locking position, the retainer including protection walls covering the tip part of the terminal locking portion from both left and right sides on the both left and right sides across the terminal locking portion, the protection wall including a protrusion projecting in the oblique forward direction, and the housing including recesses extending in the oblique forward direction for receiving the protrusions restricted in position in a vertical direction at least at the complete locking position.

According to the configuration of (1) described above, the tip part of the terminal locking portion of the retainer is covered and protected from the both left and right sides by the protection walls. Further, when a force for rotating the retainer body acts on the retainer, the recesses receive the protrusions, displacements in the vertical direction of the protection walls can be restricted and a displacement in the vertical direction of the terminal locking portion located on laterally inner sides of the protection walls can also be restricted. As a result, the locking stability of the terminal locking portion for the terminal fitting can be ensured.
(2) In the connector of (1) described above, the protrusion may be configured to contact an inner surface of the recess at the temporary locking position while being restricted in position at least in one vertical direction.

According to the configuration of (2) described above, also when the retainer is at the temporary locking position, the protection walls and, consequently, the terminal locking portion can be restricted from being displaced at least in the one vertical direction and the locking stability of the terminal locking portion for the terminal fitting can be more enhanced.
(3) In the connector of (1) or (2) described above, the protrusion may be configured to contact an inner surface of the recess at the complete locking position while being restricted from being displaced in the oblique forward direction.

According to the configuration of (3) described above, the protection walls and, consequently, the terminal locking portion can also be restricted from being displaced obliquely forward when the retainer is at the complete locking position.
(4) In the connector of any one of (1) to (3) described above, the protrusion may be fit in the entire recess at the complete locking position.

According to the configuration of (4) described above, when the retainer is at the complete locking position, the protection walls and, consequently, the terminal locking portion can be more reliably restricted from being displaced in the vertical direction and the connector can be so structured that rattling hardly occurs between the housing and the retainer.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

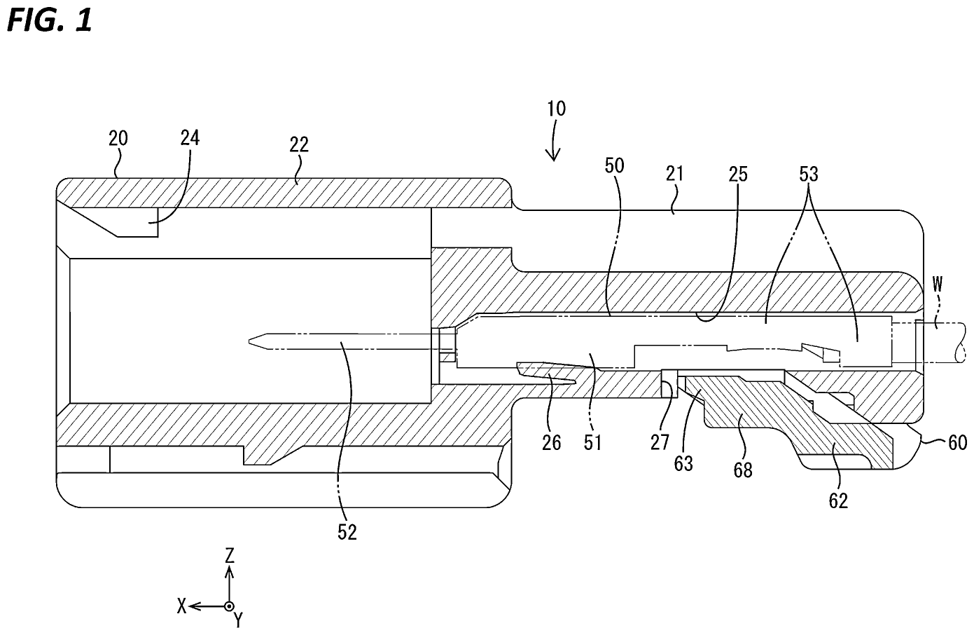

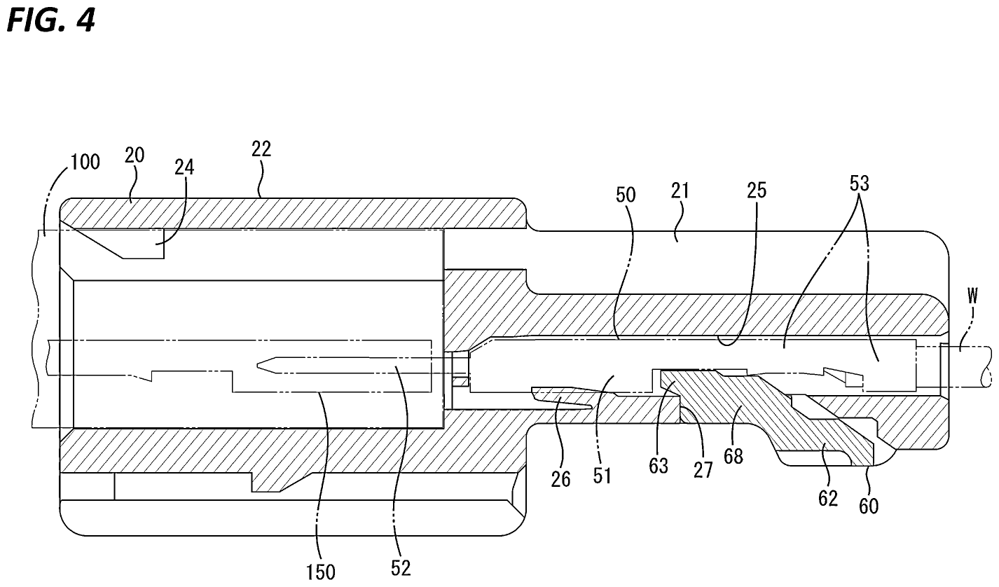

As shown in FIG. 1, a connector 10 of one embodiment is provided with terminal fittings 50, a housing 20 for accommodating the terminal fittings 50 and a retainer 60 to be arranged movably between a temporary locking position and a complete locking position with respect to the housing 20. As shown in FIG. 4, the housing 20 is connectable to a mating housing 100. Note that, in the following description, a connection direction of the housing 20 to the mating housing 100 is referred to as a forward direction concerning a front-rear direction. A vertical direction is based on a vertical direction of FIGS. 1 and 4. In FIG. 1, the forward direction, a rightward direction and an upward direction are indicated by X, Y and Z. These direction references are for convenience and do not necessarily coincide with direction references in a state where the connector 10 is installed in a vehicle or the like. Thus, a downward direction is not limited to a direction of gravity.

### Housing 20 and Terminal Fittings 50

The housing 20 is made of synthetic resin and, as shown in FIG. 1, includes a block-shaped housing body 21 and a tubular receptacle 22 projecting forward from the housing body 21.

As shown in FIG. 4, the mating housing 100 is fit into the receptacle 22. A lock portion 24 is formed to project on the upper surface of the inner wall of the receptacle 22. By locking the mating housing 100 by the lock portion 24, the housing 20 and the mating housing 100 are held in a connected state.

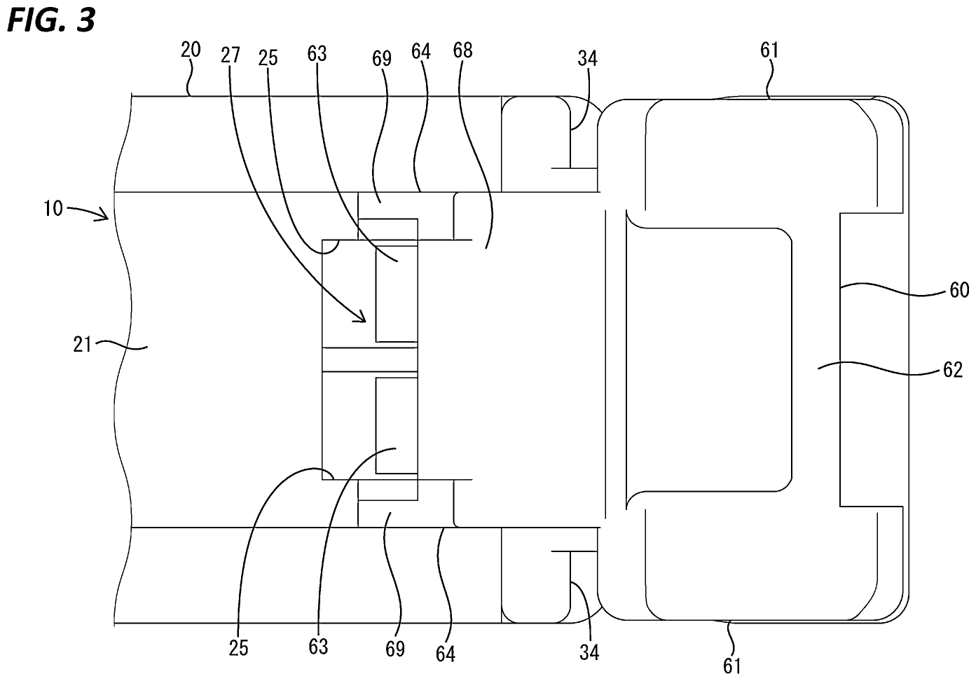

The housing body 21 is formed with a plurality of cavities 25 extending in the front-rear direction. As shown in FIG. 3, the respective cavities 25 are arranged side by side in the lateral direction inside the housing body 21. As shown in FIGS. 1 and 4, a resiliently deformable locking lance 26 is formed to project on the lower surface of the inner wall of each cavity 25.

The terminal fitting 50 is inserted into the cavity 25 from behind. The terminal fitting 50 is made of electrically conductive metal and includes a box portion 51, a tab 52 projecting forward from the box portion 51 and a barrel portion 53 located behind the box portion 51. The box portion 51 is locked by the locking lance 26. The terminal fitting 50 is primarily locked in the cavity 25 by the locking lance 26. The tab 52 is arranged to project into the receptacle 22. As shown in FIG. 4, the terminal fitting 50 is electrically connected to a mating terminal fitting 150 by inserting the tab 52 into the female mating terminal fitting 150 mounted in the mating housing 100. The barrel portion 53 is electrically and mechanically connected to an end part of a wire W.

A retainer mount hole 27 is formed to be open in a rear part of the lower surface of the housing body 21. The retainer mount hole 27 communicates with each cavity 25. A later-described retainer body 62 of the retainer 60 is insertable into the retainer mount hole 27.

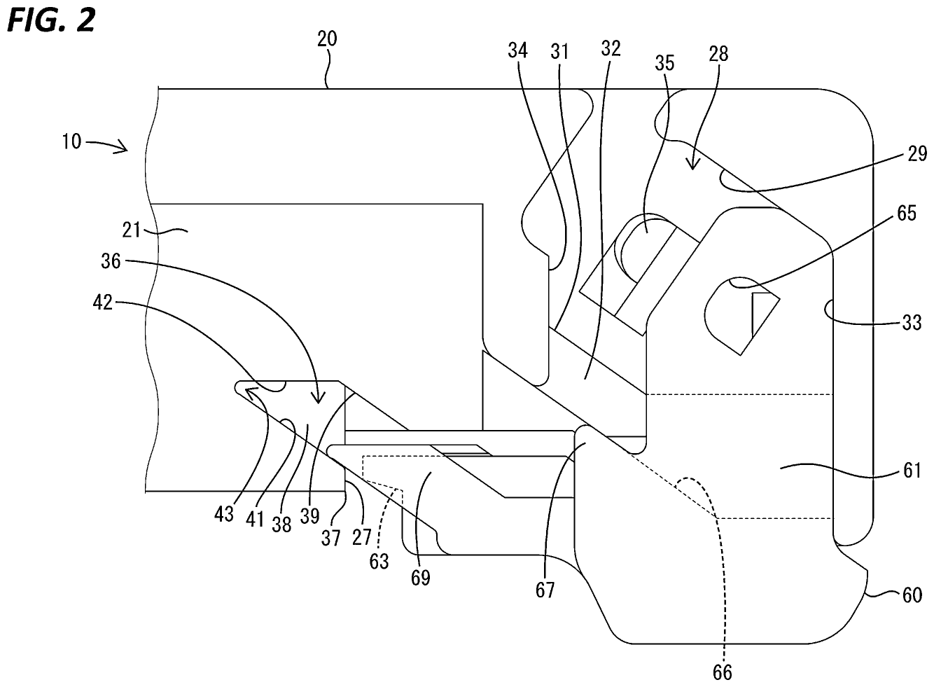

As shown in FIG. 2, both left and right side surfaces of the housing body 21 are recessed to provide guide portions 28. Similarly to the retainer mount hole 27, the guide portions 28 are formed in a rear part of the housing body 21. A later-described side wall 61 of the retainer 60 is fit into the guide portion 28. End edges located on an upper side and a lower side of the guide portion 28 are respectively configured as an upper guide surface 29 and a lower guide surface 31 for guiding a movement of the retainer 60. The upper and lower guide surfaces 29, 31 are inclined upward toward the front. The lower guide surface 31 constitutes the upper surface of a guide rib 32 extending obliquely forward.

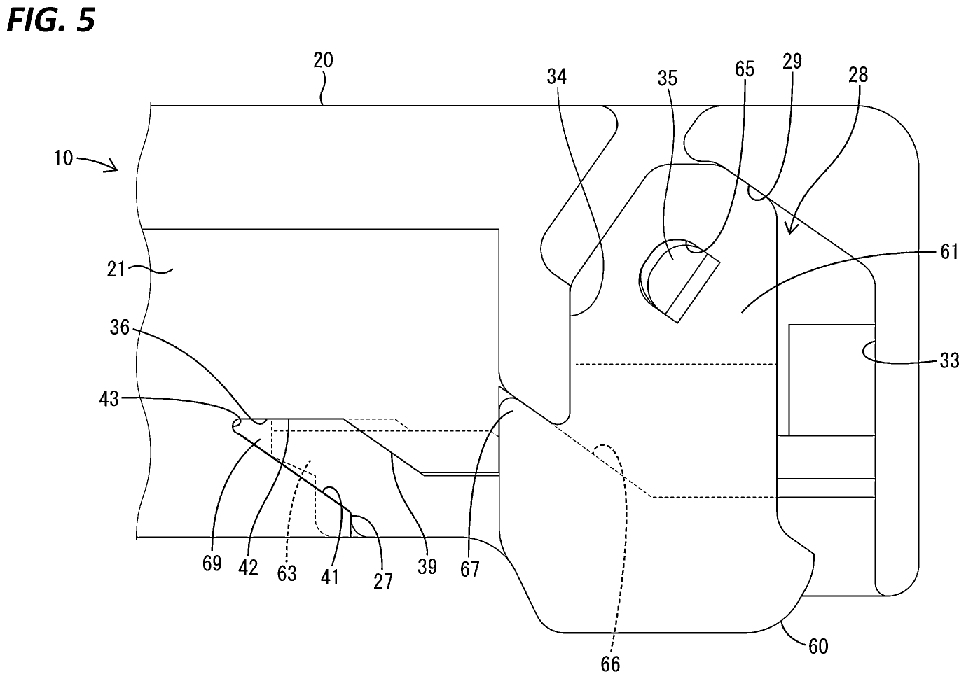

An end edge on a rear side of the guide portion 28 is configured as a rear stopper surface 33 for restricting the side wall 61 of the retainer 60 at the temporary locking position from coming out rearward. The rear stopper surface 33 is formed along the vertical direction. The rear end of the upper guide surface 29 and the upper end of the rear stopper surface 33 are connected to each other. An end edge on a front side of the guide portion 28 is configured as a front stopper surface 34 for restricting the side wall 61 of the retainer 60 from coming out forward (obliquely forward) (see FIG. 5). The front stopper surface 34 is formed along the vertical direction. As shown in FIG. 2, the front end of the guide rib 32 and the lower end of the front stopper surface 34 are connected to each other.

A holding portion 35 is formed to project on the back surface of the guide portion 28, out of the side surface of the housing body 21. The rear surface of the holding portion 35 is inclined laterally outward toward the front and inclined obliquely downward. As shown in FIG. 2, the side wall 61 of the retainer 60 contacts the rear surface of the holding portion 35.

Recesses 36 are formed in both left and right side surfaces of the housing body 21. The recess 36 receives a later-described protrusion 69 of the retainer 60 and restricts the position of a protection wall 64 including the protrusion 69 in the vertical direction.

The recess 36 is provided by recessing the side surface of the housing body 21. A rear part of the recess 36 communicates with the retainer mount hole 27 and causes an introduction opening 37 to be open in the lower surface of the housing body 21. A front part of the recess 36 and the cavity 25 adjacent to the front part of the recess 36 are partitioned by a thin side surface portion 38.

The recess 36 is shaped to extend obliquely forward toward an upper side from the introduction opening 37 as a whole. An end edge located on a rear side of the recess 36 is configured as an upper inclined surface 39 inclined forward toward the upper side. The upper inclined surface 39 can contact the protrusion 69 from above. An end edge located on a front side of the recess 36 is also configured as a lower inclined surface 41 inclined forward toward the upper side. The lower inclined surface 41 can contact the protrusion 69 from below. The upper and lower inclined surfaces 39, 41 are arranged to face in parallel to each other. An end edge located on an upper side of the recess 36 is configured as a back end surface 42 linearly extending along the front-rear direction. The back end surface 42 can contact the upper end surface of the protrusion 69 from above. The rear end of the back end surface 42 and the upper end of the upper inclined surface 39 intersect each other at an obtuse angle. The front end of the back end surface 42 and the upper end of the lower inclined surface 41 intersect each other at an acute angle. An intersecting part of the front end of the back end surface 42 and the upper end of the lower inclined surface 41 is formed into a curved shape (R shape).

### Retainer 60

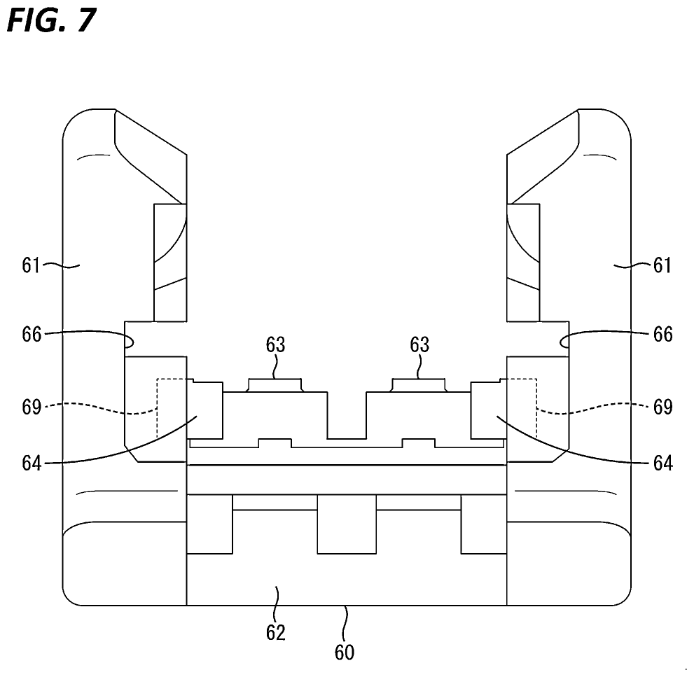

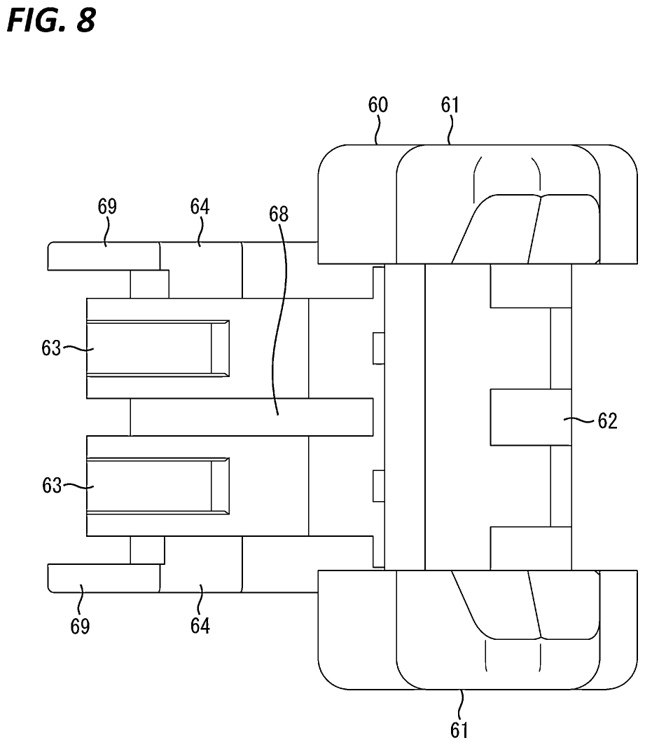

The retainer 60 is made of synthetic resin and includes, as shown in FIGS. 7 and 8, a pair of the side walls 61 facing each other in the lateral direction, the retainer body 62 bridged between the respective side walls 61, a pair of terminal locking portions 63 projecting from the retainer body 62 and a pair of the protection walls 64 connected to the retainer body 62 and covering the respective terminal locking portions 63 from both left and right sides.

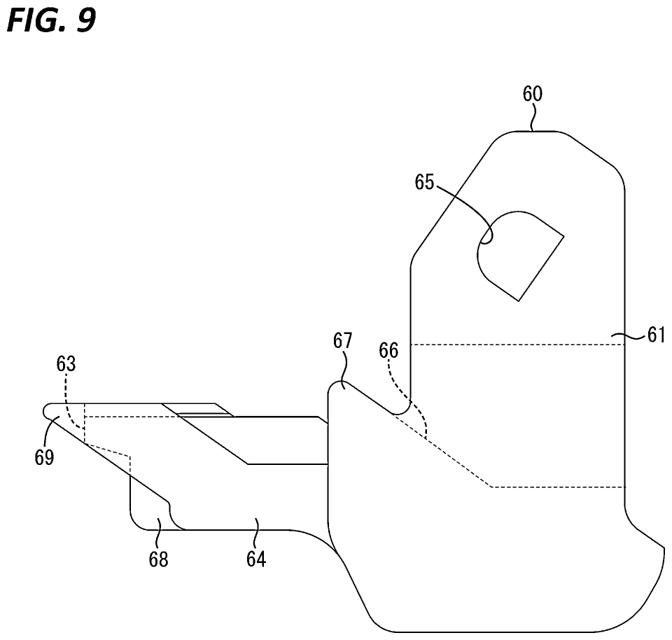

As shown in FIG. 9, each side wall 61 has a steep shape with a wall surface facing in the lateral direction, and is movably fit into the guide portion 28 of the housing body 21 (see FIGS. 2 and 5). A held portion 65 is formed to penetrate through each side wall 61. As shown in FIG. 5, the holding portion 35 is fit inside the held portion 65 at the compete locking position. The rear end surface of each side wall 61 is arranged along the vertical direction and contactably faces the rear stopper surface 33 of the housing body 21 at the temporary locking position (see FIG. 2). An upper part of the front end surface of each side wall 61 is inclined upward toward a rear side and contactably faces the rear surface of the holding portion 35 at the temporary locking position. A vertically intermediate part of the front end surface of each side wall 61 is arranged along the vertical direction and contactably faces the front stopper surface 34 of the housing body 21 at the compete locking position (see FIG. 5).

A rear part of the upper end surface of each side wall 61 is inclined upward toward the front and facing to be slidable (slide movable) on the upper guide surface 29 (see FIGS. 2 and 5). Further, the inner surfaces of the respective side walls 61 (surfaces of the respective side walls 61 facing each other) are recessed to provide guide grooves 66 (see FIG. 7) fittable to the guide ribs 32. A guided portion 67 slidable on the guide rib 32 is formed to project also on a lower part of the front end surface of each side wall 61. As shown in FIGS. 2 and 5, the upper end surface of the guided portion 67 is continuous with the lower groove surface of the guide groove 66.

As shown in FIGS. 7 and 8, the retainer body 62 extends in the lateral direction between lower end parts of the respective side walls 61 and is configured as a bottom wall part of the retainer 60. As shown in FIG. 8, the retainer body 62 includes a base portion 68 projecting forward from between the lower end parts of the respective side walls 61.

As shown in FIG. 8, the respective terminal locking portions 63 are provided to project side by side in the lateral direction on the upper surface of the base portion 68. The respective terminal locking portions 63 are insertable into the retainer mount hole 27 together with the retainer body 62. A tip part (front end part) of each terminal locking portion 62 projects forward from the base portion 68. As shown in FIG. 4, the front end surface of the terminal locking portion 63 is arranged along the vertical direction and contactably faces the rear end surface of the box portion 51 of the terminal fitting 50 at the complete locking position.

As shown in FIG. 8, the respective protection walls 64 are paired and arranged on both left and right sides across the respective terminal locking portions 63 while projecting on both left and right side surfaces of the base portion 68. A pair of the protrusions 69 are formed to project in both left and right end parts of the respective protection walls 64. The respective protrusions 69 are in the form of plates having plate surfaces facing in the lateral direction and arranged away from tip parts of the respective terminal locking portions 63 on left and right outer sides of the respective terminal locking portions 63. The respective protrusions 69 include parts covering the entire tip parts (parts projecting forward from the base portion 68) of the respective terminal locking portions 63 located on laterally inner sides and projecting further forward than the front end surfaces of the respective terminal locking portions 63.

As shown in FIG. 9, the protrusion 69 is shaped to extend obliquely forward toward the upper side from a lower end part of the protection wall 64 as a whole. The rear end surface of the protrusion 69 is inclined forward toward the upper side and slidably faces the upper inclined surface 39 of the recess 36 (see FIG. 5). The front end surface of the protrusion 69 is parallel to the rear end surface of the protrusion 69, is inclined forward toward the upper side and slidably faces the lower inclined surface 41 of the recess 36. The upper end surface of the protrusion 69 linearly extends along the front-rear direction and contacts the back end surface 42 of the recess 36 to be able to butt against this back end surface 42. The rear end of the upper end surface and the upper end of the rear end surface in the protrusion 69 intersect each other at an obtuse angle. The front end of the upper end surface and the upper end of the front end surface in the protrusion 69 intersect each other at an acute angle. An intersecting part of the front end of the upper end surface and the upper end of the front end surface in the protrusion 69 is formed into a curved shape (R shape). In short, the protrusion 69 is shaped to correspond to the recess 36 and fit into the entire recess 36 at the complete locking position.

### Functions of Connector 10

Before the terminal fittings 50 are inserted into the cavities 25, the retainer 60 is arranged at the temporary locking position with respect to the housing 20. At the temporary locking position, the guide ribs 32 of the housing 20 are fit in the guide grooves 66 of the retainer 60. Then, the upper parts of the front end surfaces of the side walls 61 contact the rear surfaces of the holding portions 35 as shown in FIG. 2, whereby a movement of the retainer 60 from the temporary locking position to the complete locking position is restricted. The rear end surfaces of the side walls 61 contact the rear stopper surfaces 33 of the guide portions 28, whereby the retainer 60 is restricted from moving rearward from the temporary locking position. The upper end surfaces of the guided portions 67 contact the lower guide surfaces 31, whereby the retainer 60 is restricted from moving downward from the temporary locking position. In this way, the retainer 60 is held at the temporary locking position with respect to the housing 20. As shown in FIG. 1, at the temporary locking position, the terminal locking portions 63 are arranged to be retracted from insertion parts for the terminal fittings 50 into the cavities 25. Thus, the insertion of the terminal fittings 50 into the cavities 25 is allowed when the retainer 60 is at the temporary locking position.

The terminal fitting 50 is inserted into the cavity 25 of the housing 20 from behind in a state connected to the end part of the wires W while the tip part of the tab 52 is facing forward. If the terminal fitting 50 is inserted to a proper depth into the cavity 25, the box portion 51 is locked by the locking lance 26 and the terminal fitting 50 is primarily restricted from coming out from the cavity 25.

As shown in FIG. 2, at the temporary locking position, the tip parts of the protrusions 69 enter the recesses 36 and the tip sides of the front end surfaces of the protrusions 69 are arranged to contact along the lower inclined surfaces 41 of the recesses 36. If a force for rotating the side walls 61 to an oblique front side acts on the retainer 60 at the temporary locking position, the terminal locking portions 63 become displaceable downward in movable ranges of the side walls 61 in the guide portions 28. However, in the case of this embodiment, the tip sides of the front end surfaces of the protrusions 69 contact the lower inclined surfaces 41 of the recesses 36, thereby suppressing downward displacements of the protrusions 69 and, consequently, the respective terminal locking portions 63.

After the respective terminal fittings 50 are inserted into the respective cavities 25, the retainer 60 is pushed to the complete locking position. If a pushing force is applied to the retainer 60, the respective side walls 61 ride on the holding portions 35 while being resiliently deformed, the groove surfaces of the guide grooves 66 and the upper end surfaces of the guided portions 67 slide along the guide ribs 32 and the rear parts of the upper end surfaces of the respective side walls 61 slide on the upper guide surfaces 29, whereby oblique forward movements of the respective side walls 61 with respect to the housing 20 are guided.

Further, the protrusions 69 slide on the upper and lower inclined surfaces 39, 41 of the recesses 36 and oblique forward movements of the protection walls 64 with respect to the housing 20 are guided. Even if a force for rotating the side walls 61 acts on the retainer 60 moving toward the complete locking position, the rotation of the protrusions 69 and, consequently, the side walls 61, is suppressed since the protrusions 69 are sandwiched in the vertical direction between the upper and lower inclined surfaces 39, 41 of the recesses 36.

When the retainer 60 reaches the complete locking position, the lower parts of the front end surfaces of the side walls 61 contact the front stopper surfaces 34 of the guide portions 28 as shown in FIG. 5, whereby any further movement (oblique forward movement) of the retainer 60 is restricted. Then, the holding portions 35 are fit into the held portions 65 of the respective side walls 61 and an oblique rearward movement of the retainer 60 is also restricted. In this way, the retainer 60 is held at the complete locking position with respect to the housing 20.

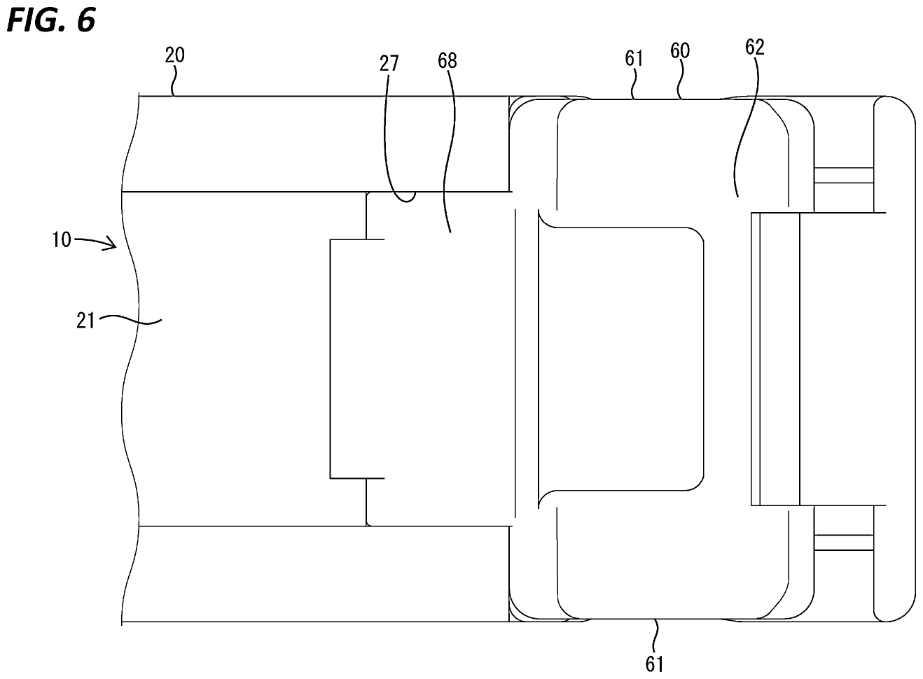

As shown in FIG. 4, at the complete locking position, the terminal locking portions 63 are arranged to be lockable to the box portions 51 of the terminal fittings 50 from behind and the terminal fittings 50 are secondarily restricted from coming out from the cavities 25. As shown in FIG. 6, the opening of the retainer mount hole 27 is closed by the base portion 68.

Further, as shown in FIG. 5, at the complete locking position, the tip parts of the protrusions 69 are fit in V-shaped spaces 43 having an acute angle, in which spaces the back end surfaces 42 and the lower inclined surfaces 41 in the recesses 36 intersect, and the upper end surfaces of the protrusions 69 contactably face the back end surfaces 42 of the recesses 36. Further, continuing from a moving process of the retainer 60, the rear end surfaces of the protrusions 69 contactably face the upper inclined surfaces 39 of the recesses 36 and the front end surfaces of the protrusions 69 contactably face the lower inclined surfaces 41 of the recesses 36.

If a force for rotating the side walls 61 acts on the retainer 60 at the complete locking position, the terminal locking portions 63 become displaceable in the movable ranges of the side walls 61 in the guide portions 28. However, in the case of this embodiment, the front end surfaces of the protrusions 69 contact the lower inclined surfaces 41 of the recesses 36, whereby the respective terminal locking portions 63 are restricted from being displaced (rotationally displaced) downward. Further, the rear end surfaces of the protrusions 69 contact the upper inclined surfaces 39 of the recesses 36 and the front end surfaces of the protrusions 69 contact the lower inclined surfaces 41 of the recesses 36, whereby the respective terminal locking portions 63 are also restricted from being displaced (rotationally displaced) upward. As a result, a state where each terminal locking portion 63 is lockable to the box portion 51 of each terminal fitting 50 is maintained.

The terminal fitting 50 may be left at an incomplete insertion position without being inserted to the proper position into the cavity 25. In this case, the terminal locking portion 63 butts against the box portion 51 of the terminal fitting 50 at the incomplete insertion position from behind in the process of moving the retainer 60 obliquely forward from the temporary locking position to the complete locking position. If the retainer 60 is further moved toward the complete locking position, the terminal fitting 50 moves forward in the cavity 25 by being pressed by the retainer 60. If the retainer 60 reaches the complete locking position, the terminal fitting 50 is pushed by the terminal locking portion 63 and inserted to the proper depth into the cavity 25. Therefore, a situation where the terminal fitting 50 is left at the incomplete insertion position can be prevented.

The retainer 60 presses each terminal fitting 50 at the incomplete insertion position in the moving process, whereby a force in the aforementioned rotation direction is applied to the retainer 60. Since the protrusions 69 are fit in the recesses 36 while being restricted in position in the vertical direction as described above in the case of this embodiment, the terminal locking portions 63 can press the terminal fittings 50 without being displaced in the vertical direction. As a result, the terminal fittings 50 are stably accommodated to the proper depth into the cavity 25.

As described above, the connector 10 of this embodiment is provided with the housing 20 formed with the cavities 25 extending in the front-rear direction, the terminal fittings 50 to be accommodated into the cavities 25 with the tip parts facing forward, and the retainer 60 to be arranged movably between the temporary locking position and the complete locking position with respect to the housing 20. The retainer 60 includes the retainer body 62 and the terminal locking portions 63 projecting forward from the retainer body 62. The retainer 60 is configured to move obliquely forward from the temporary locking position to the complete locking position with respect to the housing 20 and cause the tip parts of the terminal locking portions 63 to face the terminal fittings 50 from behind at the complete locking position. Further, the retainer 60 includes the protection walls 64 covering the tip parts of the terminal locking portions 63 from both left and right sides on the both left and right sides across the terminal locking portions 63. The protection wall 64 includes the protrusion 69 projecting obliquely forward. The housing 20 includes the recesses 36 extending obliquely forward for receiving the protrusions 69 in a state restricted in position in the vertical direction at the complete locking position.

According to this, the tip parts of the terminal locking portions 63 of the retainer 60 are protected from the both left and right sides by the protection walls 64. Further, when a force for rotating the retainer body 62 acts on the retainer 60, such as when the wire W is pulled, the recesses 36 can restrict displacements in the vertical direction of the protection walls 64 and also restrict displacements in the vertical direction of the terminal locking portions 63 located on the laterally inner sides of the protection walls 64 by receiving the protrusions 69. As a result, the locking stability of the terminal locking portions 63 for the terminal fittings 50 can be ensured.

Further, a movement of the retainer 60 with respect to the housing 20 can be guided by receiving the protrusions 69 into the recesses 36. Here, the protrusion 69 is configured to contact the lower inclined surface 41, which is an inner surface of the recess 36, at the temporary locking position. Thus, also when the retainer 60 is at the temporary locking position, downward displacements of the protection walls 64 and, consequently, the terminal locking portions 63 can be restricted and the locking stability of the terminal locking portions 63 for the terminal fittings 50 can be more enhanced.

Further, in the case of this embodiment, the protrusion 69 is configured to contact the inner surface (back end surface 42 and the front inclined surface) of the V-shaped space 43 of the recess 36 at the complete locking position with an oblique forward displacement restricted. Thus, when the retainer 60 is at the complete locking position, oblique forward displacements of the protection walls 64 and, consequently, the terminal locking portions 63, are also restricted.

Furthermore, in the case of this embodiment, the protrusion 69 is fit in the entire recess 36 at the complete locking position. Thus, when the retainer 60 is at the complete locking position, displacements in the vertical direction of the protection walls 64 and, consequently, the terminal locking portions 63 can be more reliably restricted and the connector 10 can be so structured that rattling hardly occurs between the housing 20 and the retainer 60.

### Other Embodiments of Present Disclosure

The above embodiment disclosed this time should be considered illustrative in all aspects, rather than restrictive.

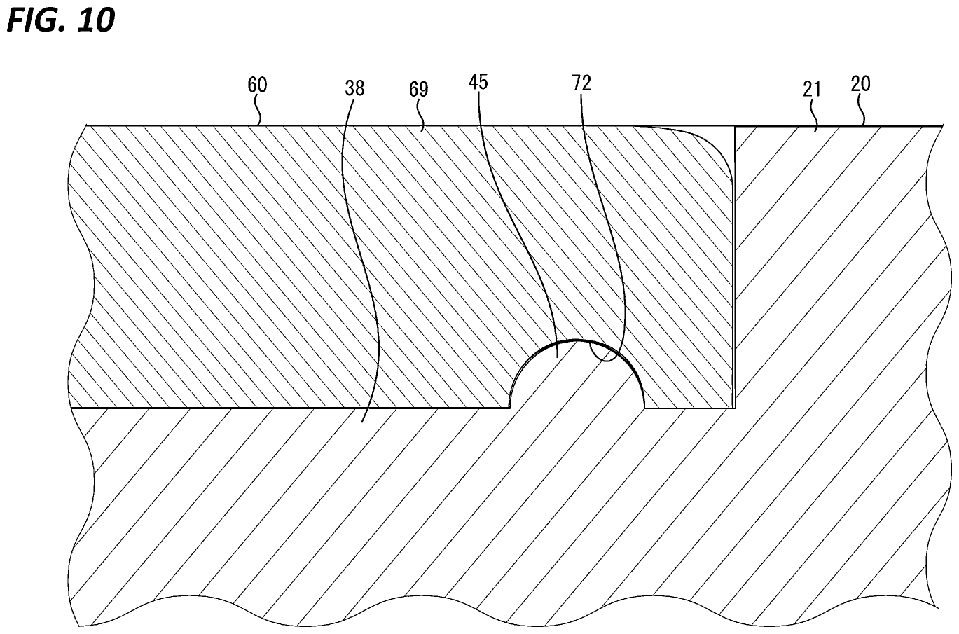

As shown in FIG. 10, a convex stopping portion 45 may be formed on the side surface portion 38 facing the recess 36 in the housing 20 and a recess-like stopped portion 72 fittable to the stopping portion 45 at the complete locking position may be formed on a tip side of the laterally inner side surface of the protrusion 69 in the retainer 60. By resiliently fitting and locking the stopped portion 72 to the stopping portion 45 at the complete locking position, a position shift of the protrusion 69 from the recess 36 can be more reliably restricted.

In the case of the above embodiment, the terminal fitting 50 is a male terminal including the tab 52 projecting forward. In contrast, a terminal fitting may be a female terminal including no tab. If the terminal fitting is a female terminal, a receptacle can be omitted from a housing.

According to the above embodiment, the recess 36 is configured to receive the protrusion 69 in the entire moving range of the retainer 60 between the temporary locking position and the complete locking position. In contrast, according to another embodiment, a protrusion may not enter a recess when a retainer is at a temporary locking position. The recess only has to receive the protrusion and restrict the position of the protrusion in the vertical direction at least when the retainer is at a complete locking position.

According to the above embodiment, the protrusion 69 is configured to contact the lower inclined surface 41 of the recess 36 at the temporary locking position. In contrast, according to another embodiment, a protrusion may be configured to contact an upper inclined surface of a recess at a temporary locking position. Alternatively, a protrusion may be configured to contact both upper and lower inclined surfaces of a recess at a temporary locking position.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing formed with a cavity extending in a front-rear direction;
a terminal fitting to be accommodated into the cavity with a tip part facing forward; and
a retainer to be arranged movably between a temporary locking position and a complete locking position with respect to the housing,
the retainer including a retainer body and a terminal locking portion projecting forward from the retainer body, the retainer being configured to move in an oblique forward direction intersecting the front-rear direction from the temporary locking position to the complete locking position with respect to the housing and cause a tip part of the terminal locking portion to face the terminal fitting from behind at the complete locking position,
the retainer including protection walls covering the tip part of the terminal locking portion from both left and right sides on the both left and right sides across the terminal locking portion,
the protection wall including a protrusion projecting in the oblique forward direction, and
the housing including recesses extending in the oblique forward direction for receiving the protrusions restricted in position in a vertical direction at least at the complete locking position.

2. The connector of claim 1, wherein the protrusion is configured to contact an inner surface of the recess at the temporary locking position while being restricted in position at least in one vertical direction.

3. The connector of claim 1, wherein the protrusion is configured to contact an inner surface of the recess at the complete locking position while being restricted from being displaced in the oblique forward direction.

4. The connector of claim 1, wherein the protrusion is fit in the entire recess at the complete locking position.
